(19) United States
(12) Patent Application Publication
(10) Pub. No.: US 2025/0173602 A1
(43) Pub. Date: May 29, 2025

(54) GENERATING PROTEIN SEQUENCES USING MACHINE LEARNING MODELS

(71) Applicants: Beijing Youzhuju Network Technology Co., Ltd., Beijing (CN); Lemon Inc., Grand Cayman (KY)

(72) Inventors: Zaixiang Zheng, Beijing (CN); Yifan Deng, Beijing (CN); Dongyu Xue, Beijing (CN); Yi Zhou, Beijing (CN); Fei Ye, Beijing (CN); Quanquan Gu, Los Angeles, CA (US)

(21) Appl. No.: 18/520,290

(22) Filed: Nov. 27, 2023

(51) Int. Cl. G06N 20/00

(52) U.S. Cl. CPC G06N 20/00

(57) ABSTRACT

The present disclosure describes techniques for generating protein sequences using machine learning models. A machine learning model is configured by implanting a structural adapter into a sequence decoder. The machine learning model is configured to generate a protein sequence from a specified structure. The machine learning model is endowed with protein structural awareness by the structural adapter. The machine learning model is equipped with protein sequential evolutionary knowledge by the sequence decoder. The machine learning model comprises the structural adapter, the sequence decoder, and a structure encoder. An initial sequence is generated based on the specified structure by the structure encoder. The protein sequence is optimized through an iterative process. The iterative process comprises progressively refining the protein sequence by iterative decoding. The structural adapter non-linearly imposes representations of the specified structure on a sequence predicted in the iterative process.

### BACKGROUND

Machine learning models are increasingly being used across a variety of industries to perform a variety of different tasks. Such tasks may include protein-design. Improved techniques for utilizing machine learning models for protein design are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating protein sequences using a machine learning model in accordance with the present disclosure.

FIG. 2 shows an example structural adapter in accordance with the present disclosure.

FIG. 3 shows an example process for generating protein sequences using a machine learning model in accordance with the present disclosure.

FIG. 4 shows an example process performed by a structural adapter in accordance with the present disclosure.

FIG. 5 shows an example process for generating protein sequences using a machine learning model in accordance with the present disclosure.

FIG. 6 shows an example process for generating protein sequences using a machine learning model in accordance with the present disclosure.

FIG. 7 shows an example process for generating protein sequences using a machine learning model in accordance with the present disclosure.

FIG. 8 shows an example process for configuring and training a machine learning model in accordance with the present disclosure.

FIG. 9 shows an example process for generating protein sequences using a machine learning model in accordance with the present disclosure.

FIG. 10 shows results of evaluating performance of a machine learning model in accordance with the present disclosure.

FIG. 11 shows results of evaluating performance of a machine learning model in accordance with the present disclosure.

FIG. 12 shows results of evaluating performance of a machine learning model in accordance with the present disclosure.

FIGS. 13A-C shows results of evaluating performance of a machine learning model in accordance with the present disclosure.

FIG. 14 shows results of evaluating performance of a machine learning model in accordance with the present disclosure.

FIGS. 15A-B shows results of evaluating performance of a machine learning model in accordance with the present disclosure.

FIG. 16 shows results of evaluating performance of a machine learning model in accordance with the present disclosure.

FIG. 17 shows results of evaluating performance of a machine learning model in accordance with the present disclosure.

FIG. 18A-B shows results of evaluating performance of a machine learning model in accordance with the present disclosure.

FIG. 19 shows results of evaluating performance of a machine learning model in accordance with the present disclosure.

FIGS. 20A-B shows results of evaluating performance of a machine learning model in accordance with the present disclosure.

FIG. 21 shows an example computing device which may be used to perform any of the techniques disclosed herein.

### DETAILED DESCRIPTION OF ILLUSTRATIVE EMBODIMENTS

Proteins are 3D-folded linear chains of amino acids that govern biological functions, such as transcription, translation, signaling, and cell cycle control. Designing protein sequences that fold into desired structures, namely structure-based protein (sequence) design, is one of the most important problems in bioengineering. Recently, the design of proteins from data using generative deep learning techniques has led to an ongoing paradigm shift from the long-established physics-based protein design methods. Significant progress has been made by several deep generative model-based approaches. These approaches formulate structure-based protein design as an end-to-end graph-to-sequence learning problem, where an encoder-decoder model M_{θ}:X→S is tasked with predicting protein sequence S given a protein backbone structure X. Typically, supervised learning is performed on such models given a certain amount of protein structure-sequence pair data.

However, despite deep generative models showing revolutionized capability in this field, the current neural structure-based protein design approaches are do not perform well when designing plausible proteins due to two major obstacles.

The first major obstacle is the limited amount of available experimentally determined protein structure data. The known protein structures in commonly used datasets (e.g., the CATH dataset) are multiple orders of magnitude smaller (<0.1%) than the sequence data in the commonly used sequence databases (e.g., UniRef). As structure-based protein design is essentially a conditional sequence learning problem, the protein sequence distribution is crucial yet remains elusive for generally data-hungry generative models due to a limited amount of available data. Therefore, existing generative models fail to holistically explore the protein sequence space and tend to yield sub-optimal sequence predictions for folds. Despite being partly remedied by data augmentation, additional predicted structure data and trainable model parameters at scale demand computation and storage overheads.

The second obstacle is the challenge presented by structurally non-deterministic regions. From a biological perspective, protein structures are sometimes not sufficiently informative, especially for those flexible regions such as loops and exposed surfaces. In these regions, residue identities can, hypothetically, be less correlated with the structural context while sequential knowledge is way more useful yet largely neglected. Existing purely structure-based approaches are prone to produce functionally invalid sequences for these regions. As such, improved techniques for structure-based protein design are needed.

Described herein are techniques that leverage protein language models to make better structure-based protein design. Protein language models may learn evolutionary knowledge of proteins from the universe of massive protein sequence data. Such comprehensive and thorough sequential knowledge can help probe functional properties and even predict protein structures from single sequences. The techniques described herein repurpose a protein language model to generate sequences prompted by the desired structure, thereby taking advantage of the protein language model's acquired sequential evolutionary knowledge. The techniques describe herein provide for strong protein designers that do not need to be trained on abundant training data.

The machine learning model (e.g., the machine learning model 101) described herein may be configured by reprogramming a sequence-based protein language model to design protein sequences of a desired fold (e.g., to perform protein inverse folding). For example, the machine learning model described herein may find, given a protein backbone structure of interest, an amino acid sequence that will fold to this structure.

Neural structure-based protein design can be formulated as an end-to-end graph-to-sequence learning problem. Formally, a parameterized encoder-decoder neural model Me is tasked with predicting the protein sequence for a protein backbone structure,

M_{θ}:X→S,

where for a protein of length L,S={Sᵢ∈Cat(20)|1≤i≤L} represents a residue sequence of 20 types of amino acids, and X={xᵢ∈ [symbol] ^{N}^{ₐₜₒₘₛ}^{×3}|1≤i≤L} denotes the spatial coordinates in 3D space for the residues of the desired protein structure with Nₐₜₒₘₛ backbone atoms (e.g., N, C_{α} and C, with O optionally). The learning objective is to find the model parameter θ that maximizes the conditional log-likelihood p(S|X;θ) given sufficient protein structure-sequence paired data.

The general workflow of these approaches may be as follows: (1) a desired protein backbone structure X is first represented as a k-nearest-neighbor (k-NN) graph in 3D space with geometric features attaching to nodes and edges of the graph; (2) A graph neural network-based encoder then takes as input the featurized graph and maps it to structural representations; and (3) a sequence decoder consumes the encoded structural representations and accordingly predicts a sequence of amino acids S that is expected to fold into the target protein structure X, in which an autoregressive decomposition p (S|X)=Πᵢ₌₁^{L} p(Sᵢ|S_{<i},X) is typically applied.

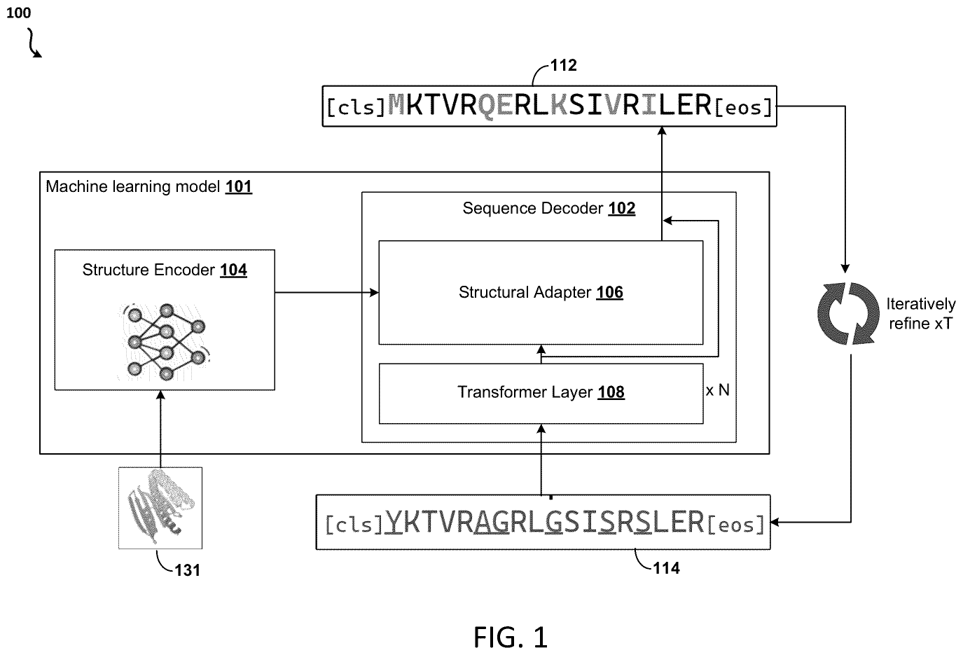

FIG. 1 shows an example system 100 for generating protein sequences in accordance with the present disclosure. The system 100 comprises a machine learning model 101. The machine learning model 101 comprises a sequence decoder 102, a structure encoder 104, and a structural adapter 106. The machine learning model 101 may be equipped with protein sequential evolutionary knowledge by the sequence decoder 102. The sequence decoder 102 may be pre-trained. The sequence decoder 102 may utilize the pretrained model weights. The sequence decoder 102 may comprise a plurality of transformer layers 108 (e.g., N transformer layers 108). Each of the transformer layers 108 may comprise a multi-head attention and a feedforward network (FFN). The multi-head attention may compute position-position interactions across a sequence, and the FFN may be applied independently at each position.

In embodiments, the sequence decoder 102 is a protein language model. Typically, a protein language model approximates the protein sequence distribution p(S) via pseudo-likelihood, wherein Πᵢ p (Sᵢ|S₋ᵢ) over a partially corrupted sequence (by being randomly masked, replaced or kept up to certain schedules) is maximized. Although the only training objective is to identify missing amino acids, a high success rate necessitates the model to learn intricate information within its sequential input, e.g., underlying evolutionary correlations and tertiary topology. For example, the sequence decoder 102 may be a pretrained protein language model. The pretrained protein language model may have learned protein sequential evolutionary knowledge from protein sequence data. The machine learning model 101 may be able to accurately handle structurally non-deterministic regions (e.g., functional loops and exposed surfaces) based on the learned sequence knowledge from the protein language model. The machine learning model 101 may be structurally sensitive, thereby better determining the nuanced sequential specificity of those protein groups of high structural similarity.

A lightweight structural adapter (e.g., the structural adapter 106) may be implanted into the sequence decoder 102 to endow the sequence decoder 102 with structural awareness. One structural adapter 106 may be placed after the last layer of the N transformer layers 108, or a structural adapter 106 may be placed after each layer of the N transformer layers 108. The structural adapter 106 may endow the sequence decoder 102 with structural awareness by providing the sequence decoder 102 with access to the structure encoder 104. The structure encoder 104 may be pretrained. Suitable structure models (e.g., architectures, hyper-parameters, etc.) may be used to parameterize the structure encoder 104.

The machine learning model 101 may be data-efficient and parameter-efficient as compared to existing protein generation models. Because the sequence decoder 102 and the structure encoder 104 may be pretrained and may already be associated with pretrained model weights and/or parameters, the machine learning model 101 does not need to be trained on an abundant amount of training data. Only the structural adapter 106 may need to be trained during a training process of the machine learning model 101. The pre-trained structure encoder 104 and/or the pre-trained sequence decoder 102 may be kept frozen during the training process of the machine learning model 101.

In embodiments, the training process of the machine learning model 101 may comprise a conditional masked language modeling (CMLM) process. CMLM is suitable for the generative purpose. Formally, given backbone structure X and sequence S=S_{masked}∪S_{obs}, CMLM requires the model to predict a set of target amino acids S_{masked}, which are randomly masked, from the remaining observed residues:

$$p ( {S}_{masked} \vert {S}_{obs} , X ; θ ) = {\prod }_{{s}_{i} ∈ {S}_{masked}} p ( {s}_{i} \vert {S}_{obs} , X ; θ ) ,$$

Here a conditional independence assumption over identities of target residues sᵢ∈S_{masked} is made, given X and S_{obs}.

Such a conditional independence assumption is almost true for structure-based protein design from the viewpoint of probabilistic graphical models (PGMs), wherein graphically represented protein structure implies that each amino acid is primarily dependent on its spatially nearest neighbors rather than considerably distant ones. With respect to CMLM only “left” contexts rather than all neighbors get considered. This indicates that such an assumption can effectively exploit the underlying structural information, thereby better formulating structure-based protein design.

The machine learning model 101 may generate an initial sequence. For example, the initial sequence may be generated by the structure encoder 104. The initial sequence may be generated based on a specified structure 131. The specified structure 131 may be a desired protein structure. For example, the machine learning model 101 may be tasked with generating a protein sequence that will fold into (e.g., form) the specified structure 131. The initial sequence may be input into the structural adapter 106. The structural adapter 106 may generate a first predicted protein sequence 112 based on the initial sequence.

Generating the protein sequence that will fold into (e.g., form) the specified structure 131 may comprise optimizing the protein sequence through an iterative process. The iterative process may comprise progressively refining the protein sequence using iterative decoding. For example, the first predicted protein sequence 112 may be refined to generate a second predicted sequence 114. The second predicted sequence 114 may then be refined to generate a third predicted sequence, and so on. The structural adapter 106 may non-linearly impose representations of the specified structure 131 on a sequence predicted in the iterative process. For example, in each iteration of the iterative process, the structural adapter 106 may non-linearly impose representations of the specified structure 131 on the sequence predicted in a previous iteration of the iterative process. Such iterative refinement may be performed until convergence, when the prediction can no longer be improved. The protein sequences generated by the machine learning model 101 may be diverse and structurally valid protein sequences, including sequences for proteins of unseen categories, such as antibodies and de novo proteins.

The iterative process may comprise sampling the predicted sequence. For example, in each iteration of the iterative process, the sequence predicted in the previous iteration of the iterative process may be sampled. To predict protein sequences from a given structure, sequences Ŝ that have high likelihoods w.r.t. p (S|X) may be sampled, where X represents a given protein backbone structure and S represents the predicted protein sequence. Particularly, Ŝ with the maximum likelihood may be obtained via greedy deterministic decoding:

$$\hat{S} = arg {max}_{S = \{ {S}_{i} \vert 1 \leq i \leq L \}} {\prod }_{i} p ( {s}_{i} \vert X ) .$$

Notably, the machine learning model 101 is trained to reconstruct a protein native sequence from its corrupted version, which enables it to iteratively refine the predicted sequence in a coarse-to-fine manner towards a better one.

To sample in such an iterative refinement manner, the structure of the Markov process may be followed and sampling may be performed sequentially S^{(t)}˜p(S^{t}|S^{(t-1)},X) by recycling the protein-language-model-based decoder for some fixed number of steps T, starting from an initial sequence S⁽⁰⁾. The initial sequence S⁽⁰⁾ can be drawn from a weaker proposal distribution parameterized by a simple linear projection to amino acid vocabulary from the features of the structure encoder 104. S⁽⁰⁾ can be regarded as the output of the structure encoder 104. The number of steps T may be tuned for a good accuracy-efficiency trade-off. Larger T usually leads to better prediction with high latency, whereas one-shot parallel generation, as a special case, can be achieved by setting T=1 when efficiency is prioritized. In embodiments, to control the diversity and speed of convergence, we consider a modified function of the categorical distribution we want to sample from such that

$$log p ( S \vert \cdot ; τ ) ∝ \frac{1}{τ} log p ( S \vert \cdot ) ,$$

where τ is the temperature.

The machine learning model 101 may be model agnostic. Any suitable pre-trained sequence decoder (e.g., protein language model) may be used as the sequence decoder 102. For example, in one embodiment, a pretrained protein language model may be used as the sequence decoder 102. Similarly, any suitable pre-trained structure encoder may be used as the structure encoder 104. For example, in one embodiment, a pretrained protein message passing neural network may be used as the structure encoder 104. the structural adapter 106 is not pre-trained. A suitable structural adapter 106 may be implanted within the sequence decoder 102 and be trained during a process of training the machine learning model 101.

The machine learning model 101 may be modularizable. Any of the sequence decoder 102, the structure encoder 104, and the structural adapter 106 may be decoupled from the others and replaced with another suitable version of that component. For example, the structure encoder 104 may be decoupled from the sequence decoder 102 and the structural adapter 106 and may be replaced with a different structure encoder.

The machine learning model 101 may be used to complement current neural structure-based sequence design models. For example, the machine learning model 101 may function as a universal and easy-to-use tool, such as a “wrapper,” that helps to integrate the advances of both protein language model and structure learning (e.g., geometric/graph NNs and protein structure prediction), facilitating future protein research.

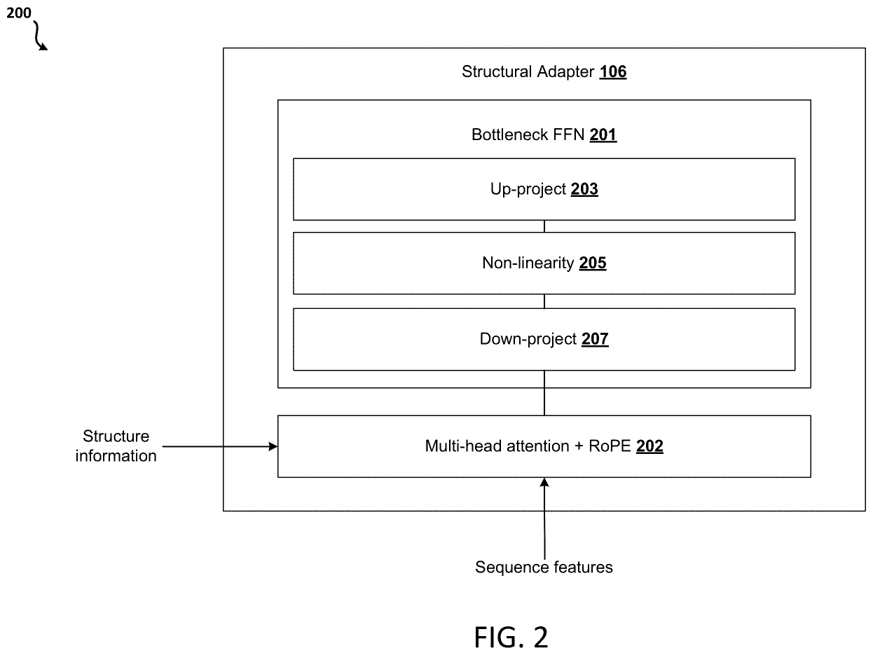

FIG. 2 shows an example of the structural adapter 106 in more detail. The structural adapter 106 may comprise a multihead attention 202. The multihead attention 202 may query structure information, such as from the structure encoder 104. Rotary Position Embedding (ROPE) may supplement the multihead attention 202 for better modeling of positional information. ROPE may encode the absolute position with a rotation matrix and incorporates the explicit relative position dependency in self-attention formulation. Notably, ROPE enables valuable properties, including the flexibility of sequence length, decaying inter-token dependency with increasing relative distances, and the capability of equipping the linear self-attention with relative position encoding.

The structural adapter 106 may comprise a bottleneck FFN 201. The bottleneck FFN 201 may non-linearly imposes and abstract features/representations of the specified structure on a sequence predicted in the iterative process of the machine learning model 100. The bottleneck FFN 201 may non-linearly re-project feature maps into another space and model the channel information to obtain the semantic information. Most hidden dimensions of the multihead attention 202 and the bottleneck FFN 201 may be determined by the instance of structure encoder 104 and sequence decoder 102 of the machine learning model 100, while the intermediate dimension of the bottleneck FFN 201 may be set to half of the model dimension. One structural adapter 106 may be placed after the last layer of the sequence decoder 102, or a structural adapter 106 may be placed after each layer of the sequence decoder 102.

As aforementioned, there are two major challenges for current neural structured-based protein design. First, from the (conditional) sequence learning perspective, the lack of abundant protein structure data makes it difficult for existing models to properly explore the protein sequence space through data-intensive supervised learning. Second, from the biological perspective, protein structures are not necessarily always informative, especially for those flexible regions such as loops and exposed surfaces. In these cases, residue identities are less correlated to the spatially associated tertiary structure while sequential evolutionary knowledge can be more decisive. For example, the activation loop in Tyrosine kinase has multiple conformations and is not well spatially constrained. However, it is known to play an important function in regulating the activity of the protein.

When pure structure-based modes are used to design this functional loop, they often produce functionally invalid repeated sequences. By contrast, the machine learning model 101 is able to generate functionally valid sequence for structurally non-deterministic regions. The machine learning model 101 is able to generate functionally valid sequence for structurally non-deterministic regions due to the acquired sequential evolutionary knowledge of the sequence decoder 102, and the sequence decoder 102's learned ability to de-noise from corrupted protein sequences.

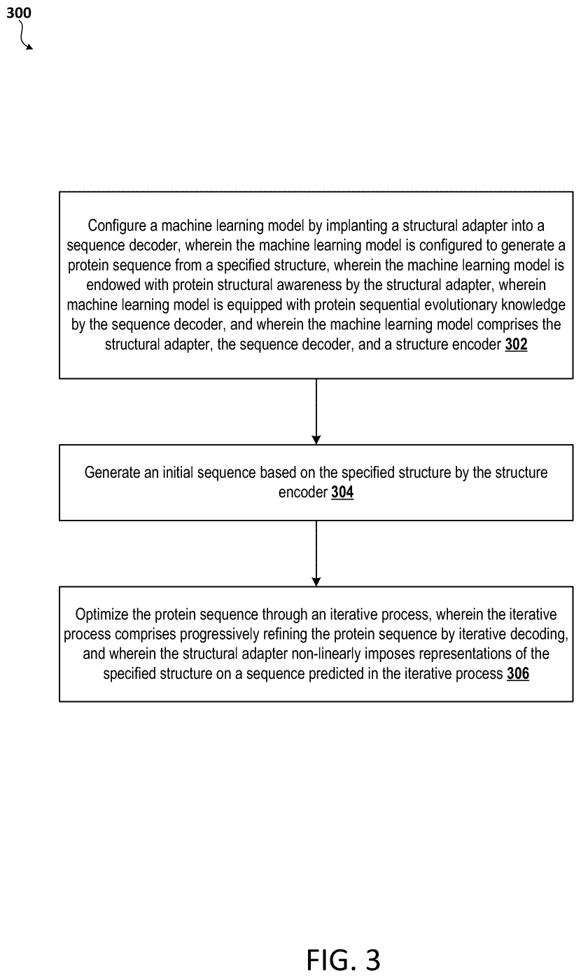

FIG. 3 illustrates an example process 300 for generating protein sequences using a machine learning model in accordance with the present disclosure. Although depicted as a sequence of operations in FIG. 3, those of ordinary skill in the art will appreciate that various embodiments may add, remove, reorder, or modify the depicted operations.

At 302, a machine learning model may be configured. The machine learning model (e.g., machine learning model 100) may comprise a structural adapter (e.g., structural adapter 106), a sequence decoder (e.g., sequence decoder 102), and a structure encoder (e.g., structure encoder 104). The machine learning model may be configured by implanting the structural adapter (e.g., structural adapter 106) into the sequence decoder. The sequence decoder may comprise a pretrained protein language model. The pretrained protein language model may have learned protein sequential evolutionary knowledge from protein sequence data. The machine learning model may be configured to generate a protein sequence from a specified structure. The machine learning model may be endowed with protein structural awareness by the structural adapter. The machine learning model may be equipped with protein sequential evolutionary knowledge by the sequence decoder.

At 304, an initial sequence may be generated. The initial sequence may be generated by the structure encoder (e.g., structure encoder 104). The initial sequence may be generated based on the specified structure. The specified structure may be a desired protein structure. The initial sequence may be input into the sequence decoder with the implanted structural adapter to generate the protein sequence that will fold into (e.g., form) the specified structure.

Generating the protein sequence that will fold into (e.g., form) the specified structure may comprise optimizing the protein sequence through an iterative process. At 306, the protein sequence may be optimized. The protein sequence may be optimized through an iterative process. The iterative process may comprise progressively refining the protein sequence by iterative decoding. The structural adapter (e.g., structural adapter 106) may non-linearly impose representations of the specified structure on a sequence predicted in the iterative process. For example, in each iteration of the iterative process, the structural adapter may non-linearly impose representations of the specified structure on the sequence predicted in a previous iteration of the iterative process. Such iterative refinement may be performed until convergence when the prediction can no longer be improved.

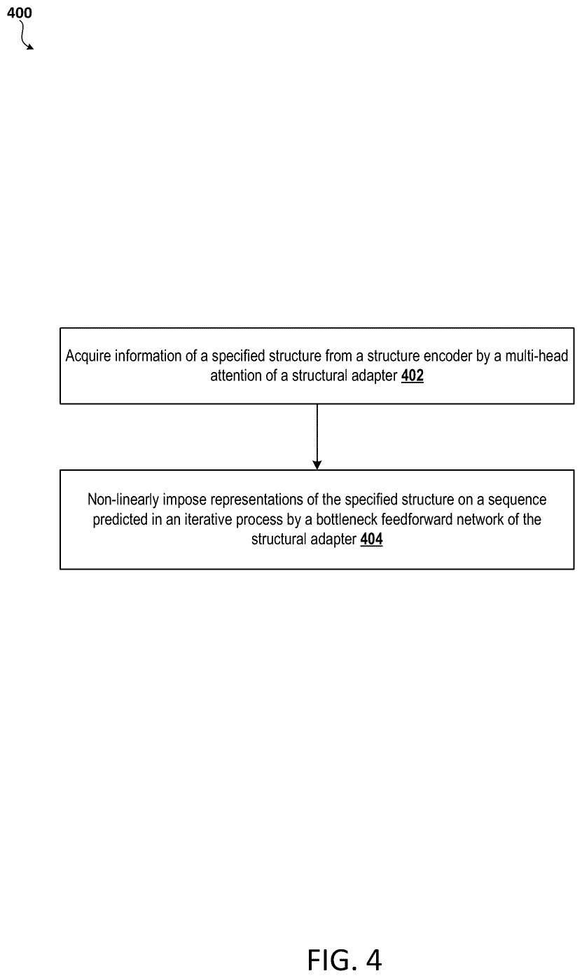

FIG. 4 illustrates an example process 400 that may be performed by a structural adapter in accordance with the present disclosure. Although depicted as a sequence of operations in FIG. 4, those of ordinary skill in the art will appreciate that various embodiments may add, remove, reorder, or modify the depicted operations.

At 402, information of a specified structure may be acquired. The information of the specified structure may be acquired from a structure encoder (e.g., structure encoder 104). The information of the specified structure may be acquired by a multi-head attention of a structural adapter (e.g., structural adapter 106). For example, the multihead attention may query structure information, such as from the structure encoder. ROPE may supplement the multihead attention for better modeling of positional information. ROPE may encode the absolute position with a rotation matrix and incorporates the explicit relative position dependency in self-attention formulation.

At 404, representations of the specified structure may be non-linearly imposed on a sequence predicted in an iterative process. The representations of the specified structure may be non-linearly imposed on the sequence predicted in the iterative process by a bottleneck FFN of the structural adapter. Most hidden dimensions of the multi-head attention and the bottleneck FFN may be determined by the instance of structure encoder and sequence decoder, while the intermediate dimension of the bottleneck FFN may be set to half of the model dimension. One structural adapter may be placed after the last layer of the sequence decoder, or a structural adapter may be placed after each layer of the sequence decoder.

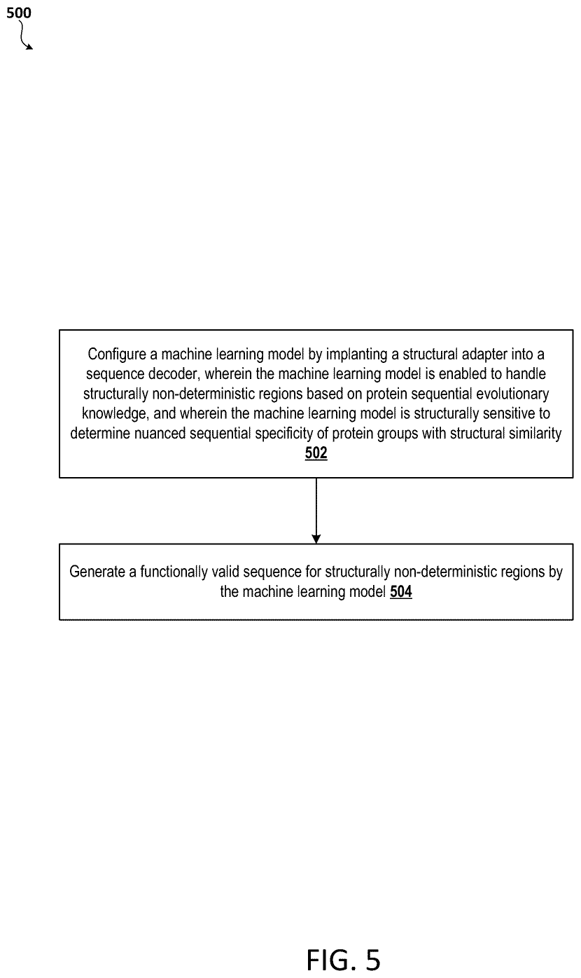

FIG. 5 illustrates an example process 500 for generating protein sequences using a machine learning model in accordance with the present disclosure. Although depicted as a sequence of operations in FIG. 5, those of ordinary skill in the art will appreciate that various embodiments may add, remove, reorder, or modify the depicted operations.

At 502, a machine learning model may be configured. The machine learning model (e.g., machine learning model 100) may comprise a structural adapter (e.g., structural adapter 106), a sequence decoder (e.g., sequence decoder 102), and a structure encoder (e.g., structure encoder 104). The machine learning model may be configured by implanting the structural adapter into the sequence decoder. The sequence decoder may comprise a pretrained protein language model. The pretrained protein language model may have learned protein sequential evolutionary knowledge from protein sequence data. The machine learning model may be configured to generate a protein sequence from a specified structure. The machine learning model may be endowed with protein structural awareness by the structural adapter. The machine learning model may be equipped with protein sequential evolutionary knowledge by the sequence decoder. The machine learning model may be structurally sensitive to determine nuanced sequential specificity of protein groups with structural similarity.

At 504, a functionally valid sequence may be generated. The functionally valid sequence may comprise a sequence for structurally non-deterministic regions. The machine learning model may generate the functionally valid sequence. The machine learning model is able to generate functionally valid sequence for structurally non-deterministic regions due to the acquired sequential evolutionary knowledge of the sequence decoder, and the sequence decoder's learned ability to de-noise from corrupted protein sequences.

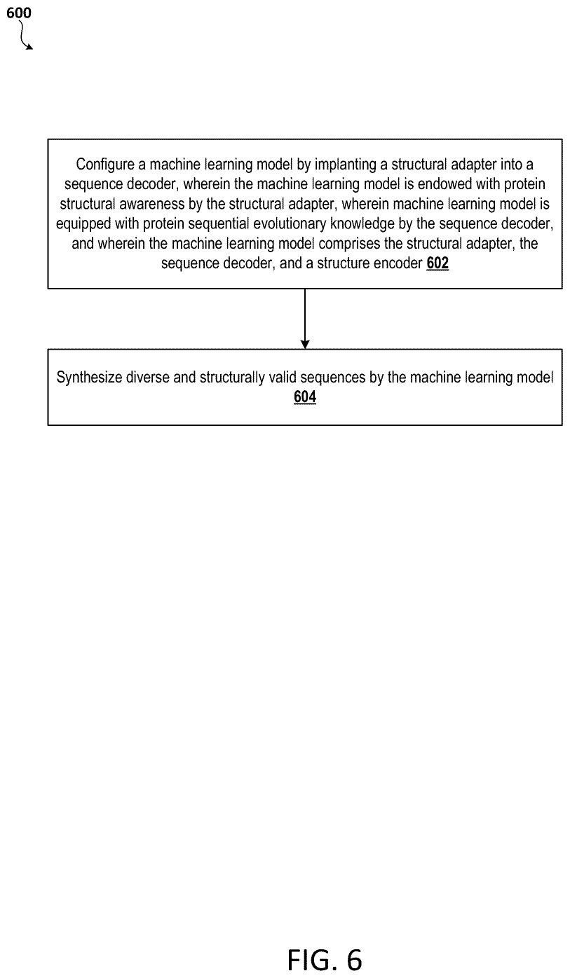

FIG. 6 illustrates an example process 600 for generating protein sequences using a machine learning model in accordance with the present disclosure. Although depicted as a sequence of operations in FIG. 6, those of ordinary skill in the art will appreciate that various embodiments may add, remove, reorder, or modify the depicted operations.

At 602, a machine learning model may be configured. The machine learning model (e.g., machine learning model 100) may comprise a structural adapter (e.g., structural adapter 106), a sequence decoder (e.g., sequence decoder 102), and a structure encoder (e.g., structure encoder 104) The machine learning model may be configured by implanting the structural adapter into the sequence decoder. The sequence decoder may comprise a pretrained protein language model. The pretrained protein language model may have learned protein sequential evolutionary knowledge from protein sequence data. The machine learning model may be configured to generate a protein sequence from a specified structure. The machine learning model may be endowed with protein structural awareness by the structural adapter. The machine learning model may be equipped with protein sequential evolutionary knowledge by the sequence decoder. At 604, diverse and structurally valid sequences may be generated. The machine learning model may generate the diverse and structurally valid sequences

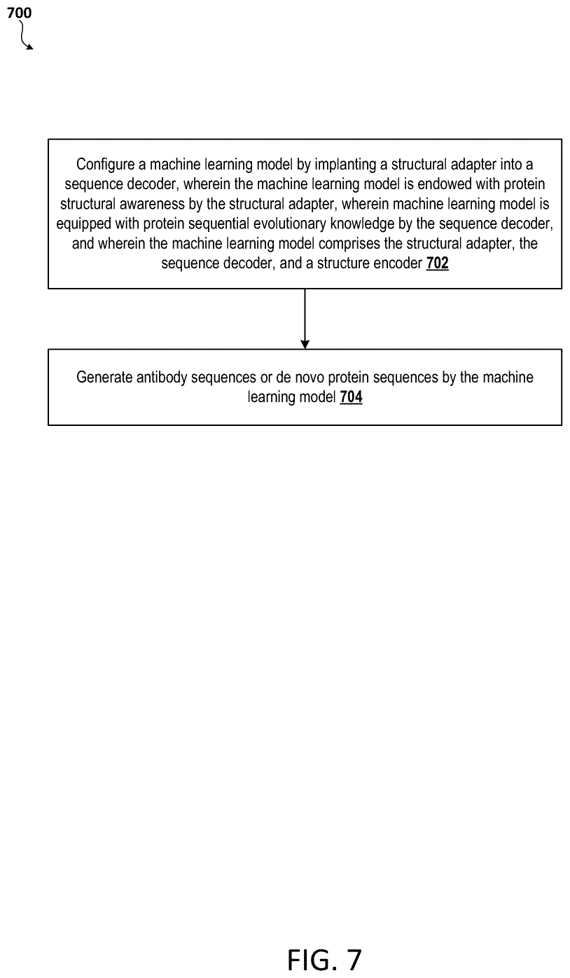

FIG. 7 illustrates an example process 700 for generating protein sequences using a machine learning model in accordance with the present disclosure. Although depicted as a sequence of operations in FIG. 7, those of ordinary skill in the art will appreciate that various embodiments may add, remove, reorder, or modify the depicted operations.

At 702, a machine learning model may be configured. The machine learning model (e.g., machine learning model 100) may comprise a structural adapter (e.g., structural adapter 106), a sequence decoder (e.g., sequence decoder 102), and a structure encoder (e.g., structure encoder 104). The machine learning model may be configured by implanting the structural adapter into the sequence decoder. The sequence decoder may comprise a pretrained protein language model. The pretrained protein language model may have learned protein sequential evolutionary knowledge from protein sequence data. The machine learning model may be configured to generate a protein sequence from a specified structure. The machine learning model may be endowed with protein structural awareness by the structural adapter. The machine learning model may be equipped with protein sequential evolutionary knowledge by the sequence decoder. The machine learning model may generate sequences for proteins of unseen categories, such as antibodies and de novo proteins. At 704, antibody sequences or de novo protein sequences may be generated. The machine learning model may generate the antibody sequences, or de novo protein sequences.

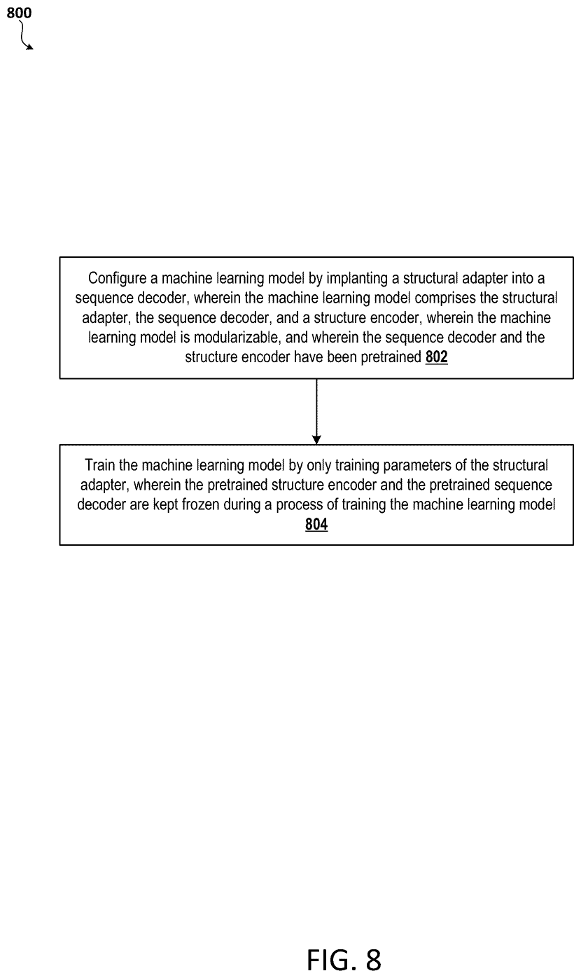

FIG. 8 illustrates an example process 800 for configuring and training a machine learning model in accordance with the present disclosure. Although depicted as a sequence of operations in FIG. 8, those of ordinary skill in the art will appreciate that various embodiments may add, remove, reorder, or modify the depicted operations.

At 802, a machine learning model may be configured. The machine learning model (e.g., machine learning model 100) may comprise a structural adapter (e.g., structural adapter 106), a sequence decoder (e.g., sequence decoder 102), and a structure encoder (e.g., structure encoder 104). The machine learning model may be configured by implanting the structural adapter into the sequence decoder. The sequence decoder may comprise a pretrained protein language model. The pretrained protein language model may have learned protein sequential evolutionary knowledge from protein sequence data. The machine learning model may be configured to generate a protein sequence from a specified structure. The machine learning model may be endowed with protein structural awareness by the structural adapter. The machine learning model may be equipped with protein sequential evolutionary knowledge by the sequence decoder.

The machine learning model may be modularizable. Any of the sequence decoder, the structure encoder, and the structural adapter may be decoupled from the others and replaced with another suitable version of that component. For example, the structure encoder may be decoupled from the sequence decoder and the structural adapter and may be replaced with a different structure encoder. As another example, the sequence decoder may be decoupled from the structure encoder and the structural adapter and may be replaced with a different sequence decoder. As another example, the structural adapter may be decoupled from the structure encoder and the sequence decoder and may be replaced with a different structural adapter.

The sequence decoder and the structure encoder may have been pretrained. For example, the sequence decoder may be a pretrained protein language model. The pretrained protein language model may have learned protein sequential evolutionary knowledge from protein sequence data. The machine learning model may be able to accurately handle structurally non-deterministic regions (e.g., functional loops and exposed surfaces) based on this learned sequence knowledge from the pretrained protein language model. The structure encoder 104 may be pretrained. The already-established structure models (e.g., architectures, hyper-parameters, etc.) may be used to parameterize the structure encoder.

If the sequence decoder and the structure encoder are pretrained, the machine learning model may be trained by only training parameters of the structural adapter (e.g., structural adapter 106). At 804, the machine learning model may be trained by only training parameters of the structural adapter. The pretrained structure encoder and/or the pretrained sequence decoder may be kept frozen during a process of training the machine learning model. Because the sequence decoder and the structure encoder are pretrained, the machine learning model is data-efficient and parameter-efficient.

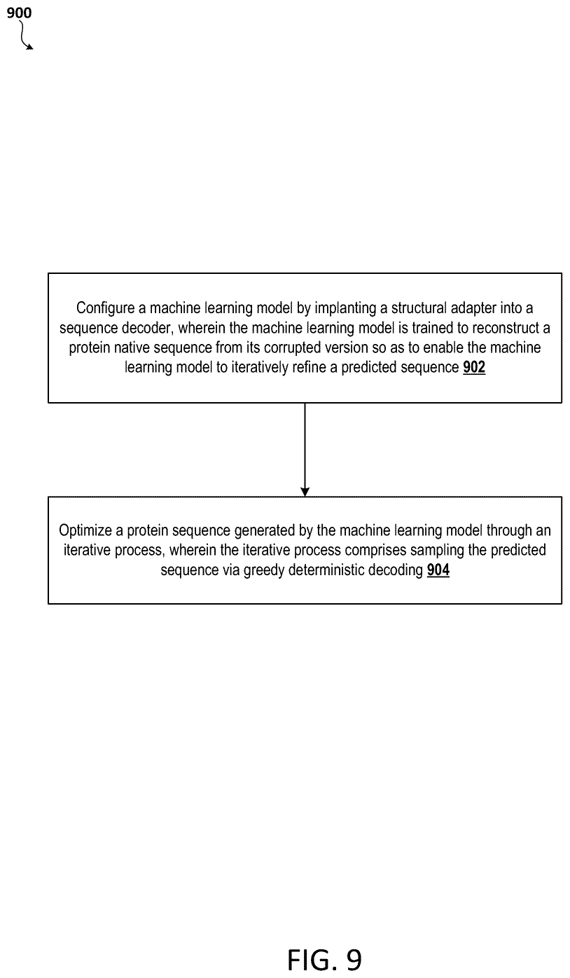

FIG. 9 illustrates an example process 900 for generating protein sequences using a machine learning model in accordance with the present disclosure. Although depicted as a sequence of operations in FIG. 9, those of ordinary skill in the art will appreciate that various embodiments may add, remove, reorder, or modify the depicted operations.

At 902, a machine learning model may be configured. The machine learning model (e.g., machine learning model 100) may comprise a structural adapter (e.g., structural adapter 106), a sequence decoder (e.g., sequence decoder 102), and a structure encoder (e.g., structure encoder 104). The machine learning model may be configured by implanting the structural adapter into the sequence decoder. The sequence decoder may comprise a pretrained protein language model. The pretrained protein language model may have learned protein sequential evolutionary knowledge from protein sequence data. The machine learning model may be configured to generate a protein sequence from a specified structure. The machine learning model may be endowed with protein structural awareness by the structural adapter. The machine learning model may be equipped with protein sequential evolutionary knowledge by the sequence decoder. The machine learning model may be trained to reconstruct a protein native sequence from its corrupted version so as to enable the machine learning model to iteratively refine a predicted sequence.

At 904, a protein sequence generated by the machine learning model may be optimized. The protein sequence may be optimized through an iterative process. The iterative process may comprise progressively refining the protein sequence using iterative decoding. The structural adapter may non-linearly impose representations of the specified structure on a sequence predicted in the iterative process. For example, in each iteration of the iterative process, the structural adapter may non-linearly impose representations of the specified structure on the sequence predicted in the previous iteration of the iterative process. Such iterative refinement may be performed until convergence, when the prediction can no longer be improved.

The iterative process may comprise sampling the predicted sequence. The predicted sequence may be sampled using greedy deterministic decoding. For example, in each iteration of the iterative process, the sequence predicted in the previous iteration of the iterative process may be sampled. To predict protein sequences from a given structure, sequences § that have high likelihoods w.r.t.p(S|X) may be sampled, where X represents a given protein backbone structure and S represents the predicted protein sequence. Particularly, S with the maximum likelihood may be obtained via greedy deterministic decoding:

$$\hat{S} = arg {max}_{S = \{ {S}_{i} \vert 1 \leq i \leq L \}} {\prod }_{i} p ( {s}_{i} \vert X ) .$$

Notably, the machine learning model is trained to reconstruct a protein native sequence from its corrupted version, which enables it to iteratively refine the predicted sequence in a coarse-to-fine manner towards a better one.

The performance of the machine learning model 101 was evaluated on a variety of benchmarks for fixed backbone protein sequence design (including single-chain proteins and multi-chain protein complexes). The performance of the machine learning model 101 for designing single-chain proteins was evaluated. The performance of the machine learning model 101 for designing single-chain proteins was evaluated using standard CATH 4.2 and 4.3 benchmarks.

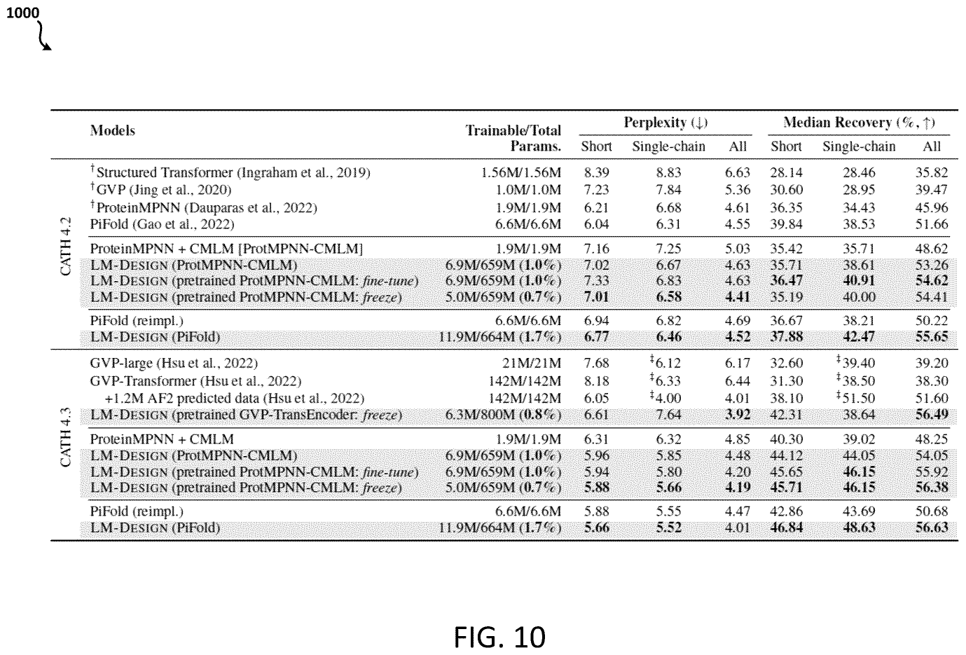

FIG. 10 shows a table 1000 illustrating the performance of the machine learning model 101 (e.g., The machine learning model 101) in designing single-chain protein compared to the recent strong baselines on the CATH benchmark, including the current strongest ones. First, as shown by the table 1000, the machine learning model 101 is more data-efficient and advances state-of-the-arts methods with a large margin without any additional data. On the more commonly-used CATH 4.2 benchmark, improving protein featurizing capability structure encoders, from the vanilla message-passing (graph) neural networks to more complicated ones improved performance to some extent, but this was limited to the under-representative protein sequence distribution due to the data shortage of experimentally determined CATH datasets. By taking advantage of massively pretrained protein language models, the proposed machine learning model 101 improves ProteinMPNN+CMLM by 4.4% on CATH 4.2 (48.62%→52.99%) and 5.8% on CATH 4.3 (48.25%→54.05%), setting the new state-of-the-arts without using any augmented data.

Second, the machine learning model 101 can be modularizable and may further benefit from pretrained structure models. Instead of learning structure encoders from scratch, the machine learning model 101 can leverage pretrained structure models as encoders, which can be fine-tuned together with the structural adapter or kept frozen. As evidenced by the little difference in sequence recovery, freezing may be the best practice. In this case, only a tiny proportion of parameters (e.g., those of the structural adapter) are trainable, and the machine learning model 101 quickly converges with better results in a negligible overhead of ten epochs. The machine learning model 101 with an encoder from GVP-Transformer, which was built on 1.2M AF2 predicted data, gave rise to a ˜5% further improvement.

Third, the more advanced the structure encoder becomes, the stronger the machine learning model 101 performs. Since the machine learning model 101 is a general-purpose framework that can make the most of the progress of protein structure models, it was evaluated whether the performance of the machine learning model 101 can be improved with stronger structure encoders. A variant of the machine learning model 101 was built upon PiFold, a recent and performant structure-based design model. As shown in the table 1000 of FIG. 10, the machine learning model 101 improves PiFold by at least 5.43% in terms of sequence recovery, yielding impressive 55.65% and 56.63% on CATH 4.2 and 4.3 datasets. These results demonstrate that the machine learning model 101 is a general-purpose approach for structure-based sequence design, which is compatibility-friendly and hence fully leverages the advances of protein structure learners.

The performance of the machine learning model 101 for designing multi-chain proteins was evaluated. A protein functions only when it docks, combines, and interacts with other macro-molecules, composing multi-chain protein complexes. As such, studying protein sequence design for multi-chain assemble structures is crucial for drug design. The multi-chain complex dataset curated by Dauparas was used to evaluate the performance of the machine learning model 101 for designing multi-chain proteins. The performance of the machine learning model 101 for designing multi-chain proteins was evaluated using the same training settings as in the single-chain scenario.

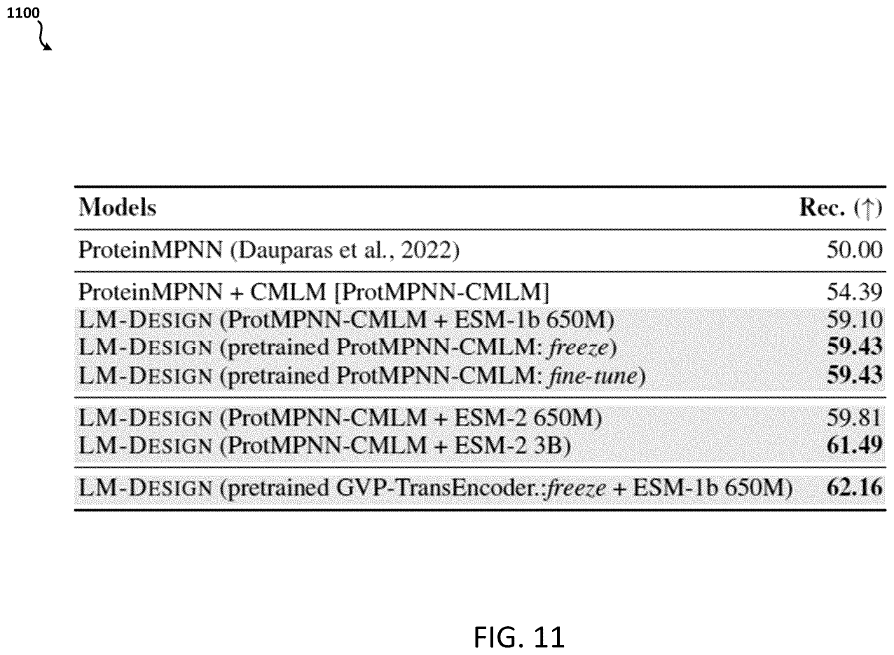

The results of this evaluation are shown in the table 1100 of FIG. 11. As shown in the table 1100, CMLM can better formulate and train ProteinMPNN than the original autoregressive version with teacher-forcing. Upon a more competent system of ProteinMPNN+CMLM, The machine learning model 101 yields a near 60% sequence recovery of multi-chain protein assembles. When further integrated with protein language model at scale (i.e., ESM-2) or better structure encoder (i.e., GVP-TransformerEncoder), it can even achieve more impressive scores of 61.49% and 62.16%, respectively. These results show that the machine learning model 101 can not only design single-chain proteins, which are mostly studied in previous works but also be used for designing multi-chain protein complexes. This makes the machine learning model 101 more general-purpose in terms of the categories and scenarios where it can be deployed, and opens opportunities to use it for designing specific protein complexes, such as antigen-antibody or protein-ligand assemblies.

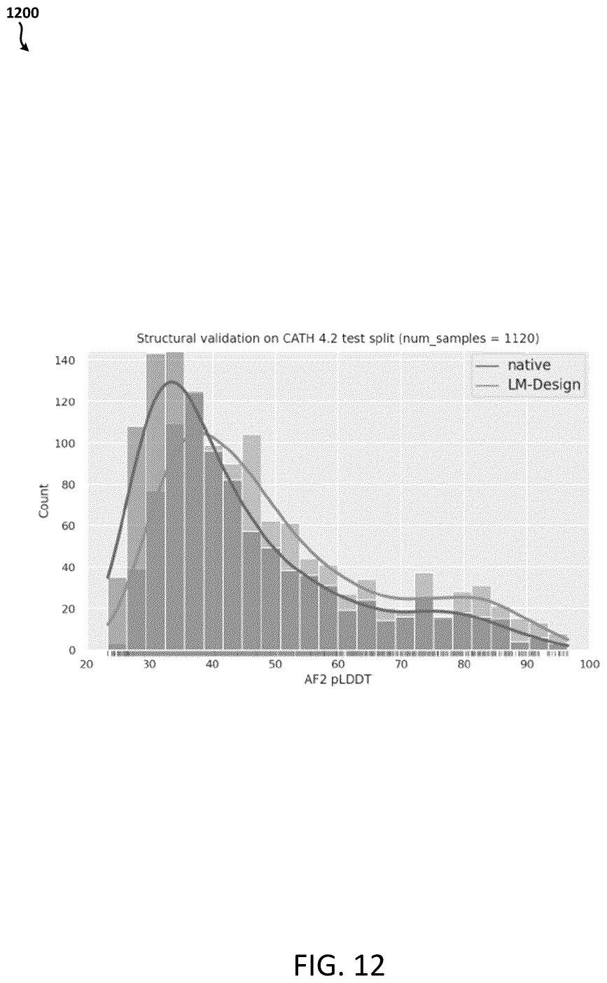

The structural validity of the machine learning model 101 was evaluated. Given that experimental assessment is not available, the most famous in silico structure prediction protocol, i.e. AlphaFold 2, was used to evaluate the structural validity of the machine learning model 101. The pLDDT score of AF2 was used as the evaluation metric and the evaluation configurations as in Dauparas were followed, where AF2 takes as input only single sequences (native sequences and our designs) while no multiple sequence alignments (MSAs) are provided. All 1120 proteins in the CATH 4.2 test split were redesigned. As shown in the graph 1200 of FIG. 12, the machine learning model 101's redesigns are predicted, by AF2, to adopt the given backbone structures more confidently than the native sequences, implying higher structural stability of our redesigns. This is because, where no co-evolutionary information of homologous sequences is exposed to AF2, the machine learning model 101 exploits the full potential of sequential co-evolutionary knowledge that the protein language model learns from massive protein sequences.

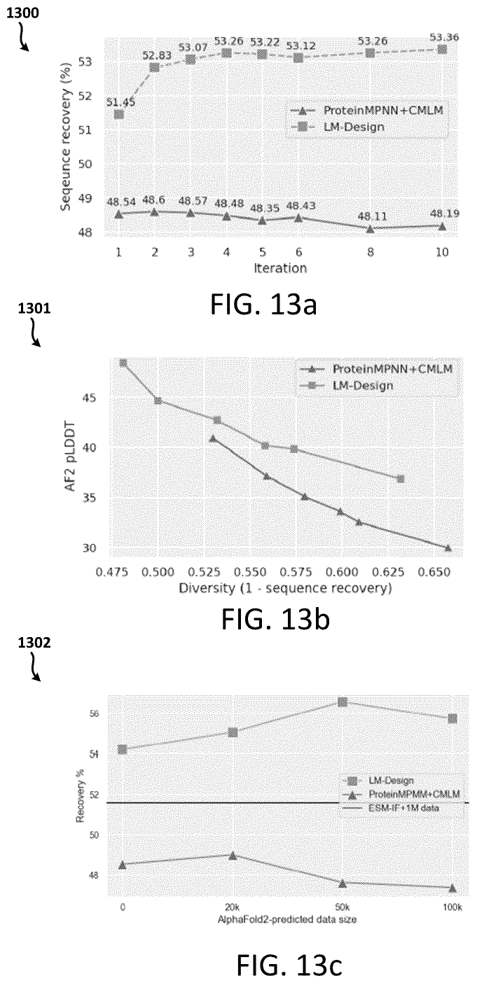

Iterative refinement gives rise to accurate sequence design. Since the machine learning model 101 is trained to denoise, iterative decoding can be exploited to progressively refine its predictions towards a better one. As shown in the chart 1300 of FIG. 13A, even without iterative refinement, the machine learning model 101 performs sufficiently well, while recycling the-protein-language-model-based decoder for the machine learning model 101 yields 1˜2% gains. This shows that iterative refinement is an effective strategy for sequence design if models are set up under a denoising learning scheme. Significant further improvement eliminates if iterating beyond six rounds, resulting in acceptable sampling efficiency.

While recent protein sequence design approaches have focused on maximizing native sequence recovery, this is not necessarily optimal for actual protein design applications, for which novelty also matters. To this end, the temperatures (τ∈[0.1, 0.5, 1.0, 1.2, 1.5]) were manipulated to control the diversity of sampled sequences that are dissimilar to the native ones at different levels. The design accuracy (in AF2 pLDDT) was evaluated as a function of diversity. The chart 1301 of FIG. 13B shows that the machine learning model 101 yields diverse yet more accurate designs over ProteinMPNN, manifesting the potential of practical values of the machine learning model 101 in real-world scenarios

The effects of scaling with respect to data size and model size were evaluated. The machine learning model 101 works well with data augmentation via incorporating predicted structures from AlphaFold 2. Different scales of data augmentation were performed. As the results in the chart 1302 of FIG. 13C show, both of the methods obtain better results with 20k data augmentation. While ProteinMPNN+CMLM drops at 50k, the machine learning model 101 keeps increasing and finally drops at 100k. That is because the machine learning model 101 has 6.9M parameters while ProteinMPNN+CMLM only has 1.6M parameters.

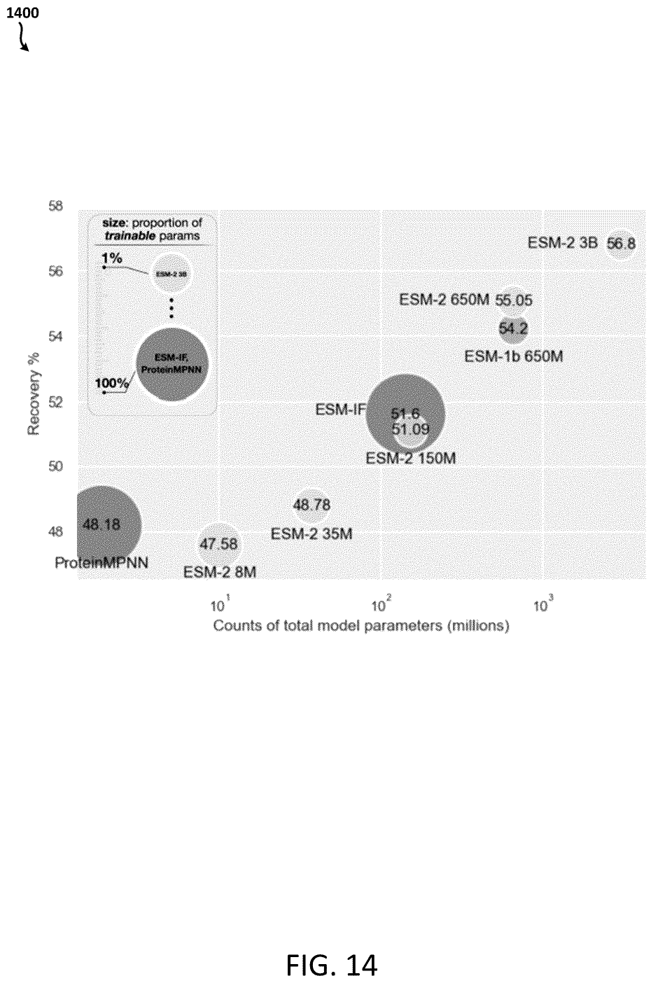

The machine learning model 101 is scalable yet parameter-efficient: scaling law with respect to model sizes of the protein language model using ESM-2 series. To study the impact of the scale of pLMs, the machine learning model 101's decoder was switched from ESM-1b (145M) to ESM-2 series, with parameters (params) ranging from 8M to 3B. As shown in the graph 1400 of FIG. 14, the performance of the machine learning model 101 increases with model scaling. In particular, a clear (log) scaling law is shown. In contrast to existing strong systems which require expensive training of hundreds of millions of parameters, the machine learning model 101 is way more parameter-efficient only needing <1% trainable parameters with respect to the parameters of the corresponding the protein language model. In the extreme case, the largest ESM-2 3B-based variant has 22M trainable out of 3B total parameters (0.07%) and achieves the highest accuracy of 56.8%. This strong connection between protein and natural languages on large language models gives rise to exciting potentials to empower protein research with cutting-edge advances in general AI.

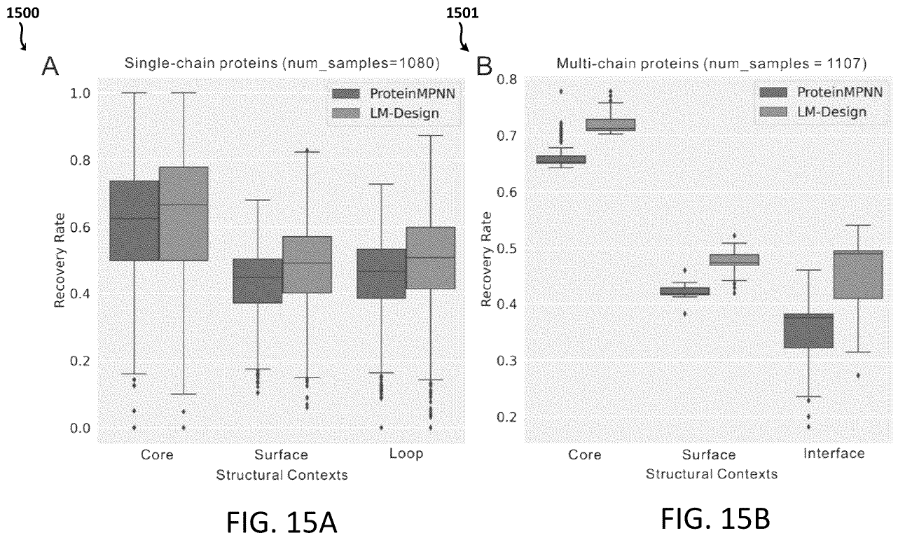

The machine learning model 101 effectively exploits the potential of both structural and sequential capabilities. To further understand the action mechanism of the machine learning model 101, its performance was dissected based on distinct structural contexts, either with high structural constraints or low constraints. As shown in the chart 1500 of FIG. 15A, for single-chain proteins in the CATH dataset, structured-based ProteinMPNN shows high sequence recovery rates on structurally constrained residues in the folding core, and low recovery rates on structurally less-constrained residues on surface area and loops. The machine learning model 101 can effectively enhance the sequence recovery rates on structurally-constrained and less-constrained residues. Similar observations can be found for multi-chain complex proteins as shown in the chart 1501 of FIG. 15B. Although ProteinMPNN achieves high sequence recovery rates on folding core residues, it shows compromised performance on residues in the binding interface and exposed regions. The machine learning model 101 can generally improve sequence recovery rates in different structural contexts.

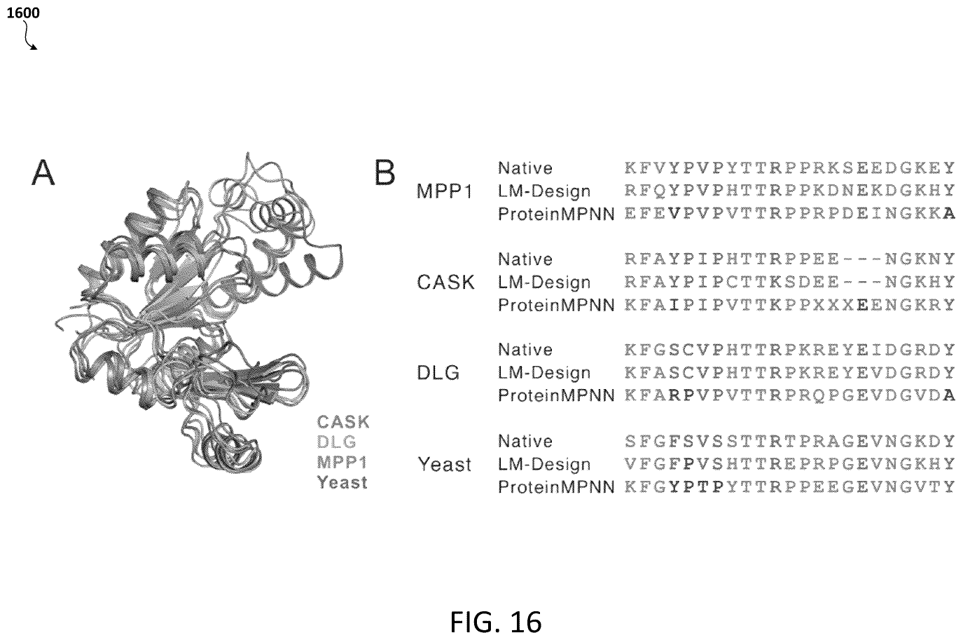

It was evaluated whether the machine learning model 101 is sensitive to structure inputs. To evaluate this problem, four proteins sharing similar structures but having distinct sequences with specific functions were collected. The machine learning model 101's performance for designing specific functional sequences for these four proteins was evaluated. As shown in the results 1600 of FIG. 16, the machine learning model 101 can predict functional specific sequences for each of the proteins, showing that the machine learning model 101 is highly sensitive to structure variations.

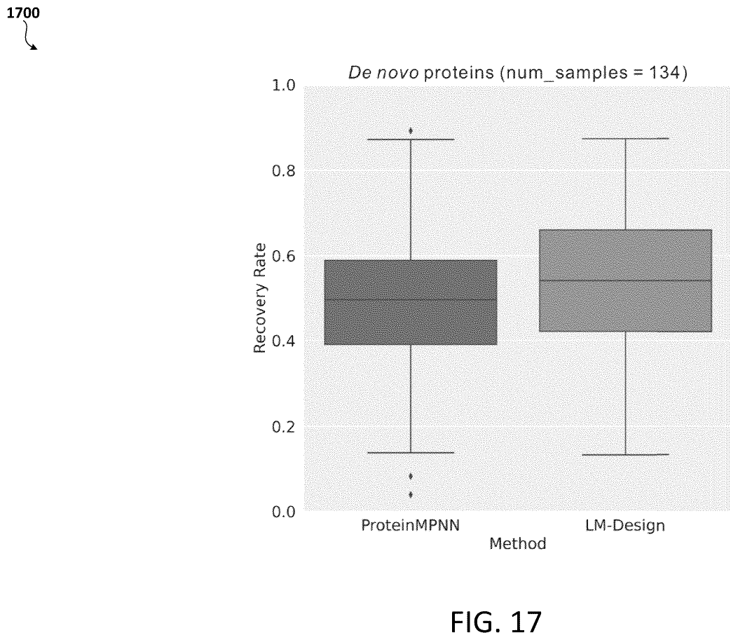

De novo protein design explores the full protein sequence space for a new range of folds with high stability. In the last decade, advanced computational methods have been developed to design protein structures with atomic-level accuracy. To evaluate whether the machine learning model 101 can generalize to de novo proteins, a de novo protein dataset was compiled by collecting 134 de novo protein monomers with different folds from Protein Data Bank. The performance of the machine learning model 101 and ProteinMPNN was evaluated using this dataset showing an average recovery rate of 48.7%. As shown in the chart 1700 of FIG. 17, the machine learning model 101 can recover the sequence with a significantly higher rate of 58.7%, suggesting a better generalization capability on designed proteins.

Designing targeted antibodies for different antigens is one of the potential treatments for many diseases that currently cannot be cured. Antibody design is formulated as sequence infilling for complementary-determining regions (CDRs) given contexts (i.e., antigen and antibody frameworks). However, the commonly used metric of sequence recovery (i.e., AAR, amino acid recovery) can be flawed as a “mode collapse” problem often occurs due to extremely limited antibody data. Therefore, a package of five metrics regarding salient regions recovery, hallucinated sequence pattern, and entropy of predicted distribution was designed for a more comprehensive evaluation. Two kinds of experiments were conducted on the RAbD dataset in designing CDR-H3 sequences given either true complex structures or predicted ones.

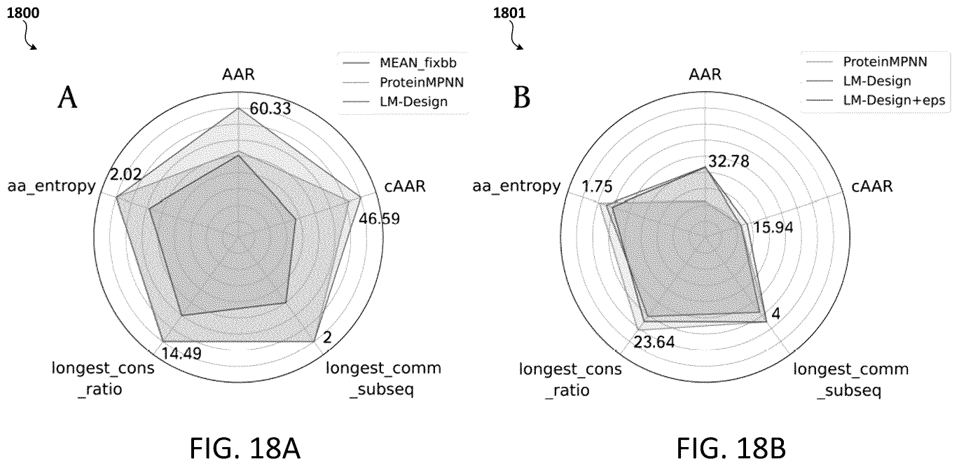

For using true structures, the performance of the machine learning model 101 was compared with ProteinMPNN and MEAN, the SoTA neural antibody design approach using its fixbb mode. As shown by the results 1800 of FIG. 18A, the machine learning model 101 outperforms antibody-specific MEAN model in terms of all evaluation aspects, showing that that models for general protein can effectively avoid mode failure while the protein language model helps facilitate antibody design. For predicted structures, the structures are predicted by MEAN. As shown in the results 1801 of FIG. 18B, the performance of the machine learning model 101 and ProteinMPNN decreases significantly, implying they are fragile for predicted structures. In contrast, the machine learning model 101+eps, where spatial perturbation is injected to the training structures, shows stronger robustness hence better performance, suggesting the need of counter-adversarial considerations for structure-based sequence models to enhance generalizability.

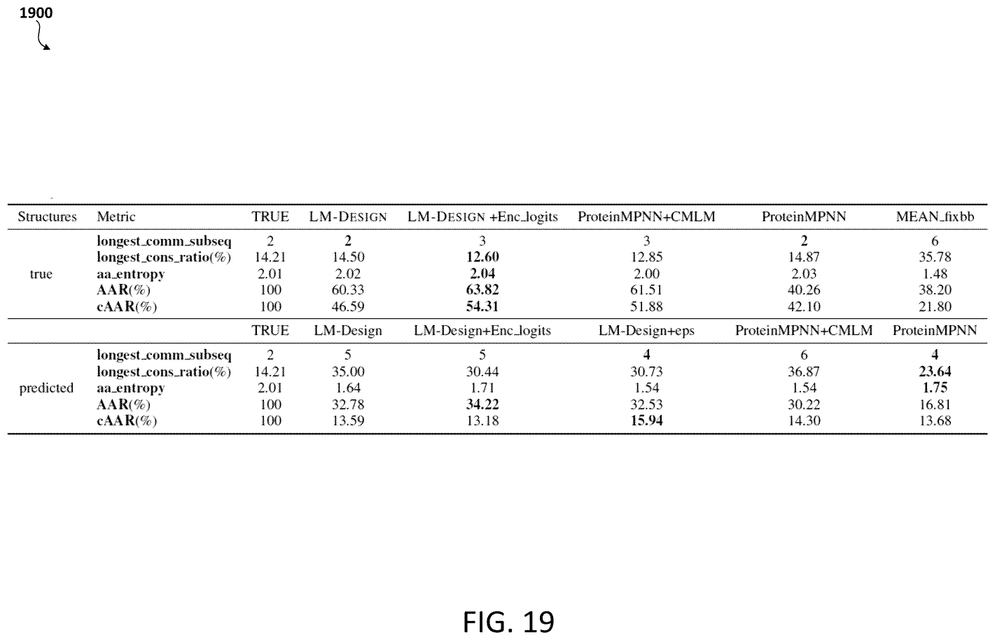

The performance of the machine learning model 101 for sequence design on true structures was evaluated. MEAN is a method specially designed for co-designing CDR structures and sequences. Open-source code of MEAN and data (e.g., data filtered down from 3127 to 2901 to remove the proteins that lacked atomic information) were used to retrain fixbb mode MEAN in this experiment. The experiment results are shown in the table 1900 of FIG. 19. In the first experiment, the machine learning model 101 and ProteinMPNN+CMLM achieve far better performance than the original ProteinMPNN, and also outperformed MEAN in fixbb mode. Among all the five metrics, the performance gap between the machine learning model 101 and ProteinMPNN+CMLM in cAAR is greater than the others. cAAR is the AAR calculated at the actual interaction position, which can better reflect the model's understanding of complex protein structures and interactions, higher is better.

The machine learning model 101 may “forget” certain structural information, resulting in a significant decline in cAAR, which is closely related to structure. To avoid this “forgetting” of the structure, the output logits of the structure encoder may be added to the machine learning model 101's output logits to enhance the impact of the structure on the predicted sequence. Finally, the machine learning model 101 +Enc_Logits achieves the best performance in four of the five metrics.

The performance of the machine learning model 101 for sequence design on predicted structures was evaluated. The original ProteinMPNN achieves the best performance in three metrics of diversity, but, as shown in the table 1900 of FIG. 19, shows great disadvantages in AAR. The machine learning model 101 and the machine learning model 101 +Enc logits have higher AAR, while ProteinMPNN+CMLM have a better cAAR. However, all methods show a huge performance degradation when using the predicted structure instead of the true structure, and this phenomenon shows the sensitivity of antibody design tasks to structural changes. To mitigate this degradation, as the true structure of the CDR region is usually not known in actual antibody design tasks, spatial perturbation was injected into the machine learning model 101's training structure. The resulting model (e.g., the machine learning model 101+eps) achieves significant improvements in cAAR, proving that tolerance for structural bias is helpful for the actual antibody sequence design task.

Thus, in antibody sequence design tasks, the machine learning model 101 and ProteinMPNN+CMLM can greatly improve the accuracy of the generated sequence at the expense of limited diversity. More specifically, the machine learning model 101 discards some perception of structure awareness based on ProteinMPNN+CMLM and gains a stronger ability to model sequences.

The performance of the machine learning model 101 to generalize to fixed-backbone sequence design on de novo proteins was evaluated. To test the machine learning model 101's generalization capability, 134 single-chain de novo proteins (length ≤30) were compiled from the PDB data bank. The structures of these samples were determined by X-ray crystallography or cryo-EM to better than 3.5 Å resolution The sequences were clustered at 30% sequence identity cutoff using mmseqs2.

The machine learning model 101 can be also combined with data augmentation, where additional large amounts of predicted protein structures by AlphaFold 2 are leveraged. Due to the limited amount of experimentally determined protein structure data and the surge of protein structure prediction models (e.g., AlphaFold 2), a natural idea for better protein inverse folding is to use the protein structure data predicted by AlphaFold 2 for data augmentation, which is similar to the back-translation in NLP area. For the protein design task, X and Y are the sets of protein structure coordinates and protein sequences. The goal is to learn a mapping f: X→Y while AlphaFold 2 has learned a mapping g: Y→X. Those protein sequences without structures are denoted as U_{y}⊂Y. For any sequence γᵤ∈U_{y}, we can predict its structure [symbol] =g(yᵤ) and add ( [symbol] yᵤ) to our training set.

The UniRef50 database is a sequence database that has over 50 million clusters at 50% sequence identity, and ESM-IF predicts structures of 12 million sequences in UniRef50 using AlphaFold 2. SWISS-PROT is a curated protein sequence database that strives to provide a high level of annotation, a minimal level of redundancy, and a high level of integration with other databases.

In order to prevent data leakage introduced by data augmentation, proteins that have the same fold as the proteins in validation and test splits need to be excluded. SWISS-PROT sequences were annotated with CATH fold classification according to the Gene3D database with hmmsearch. Filtering based on all CATH folds from validation and test splits was performed, and a sub-set of 100,000 examples was randomly selected from the filtered dataset. The random seed was fixed and 20,000 and 50,000 sequences were randomly selected for different scales of data augmentation.

In order to understand how the machine learning model 101 improves protein design, the performance of the machine learning model 101 was evaluated based on dissected structural contexts (folding core residues, surface exposed residues, residues located on loops, and residues located on complex interfaces). The dictionary of structural contexts is obtained by using the widely used DSSP (Kabsch & Sander, 1983) and biopython (Cock et al., 2009) tools. Solvent accessible surface area analysis from DSSP calculates the ratio of solvent accessible surface area to the maximum possible solvent accessible surface area for each residue. A cutting threshold of 0.1 is chosen to classify residues located in the folding core and on the exposed surface. DSSP is also used to provide secondary structure labels. Those residues showing turn, bend, and none secondary structure patterns are labeled as loops in this study. When the structural context label is obtained for each residue, the average recovery rate is calculated on PDB structures.

As shown in FIGS. 15A-B, residues in the folding core with more structural constraints display better sequence recovery rates than surface exposed and loop residues using both the structure-based ProteinMPNN and sequence-based machine learning model 101. Notably, the residues in the binding interface of multichain proteins show a poor recovery rate, suggesting the limited representation capability of existing structure-based methods in interaction interface design. The machine learning model 101 can generally improve sequence recovery rates in different structural contexts, including the interaction interfaces.

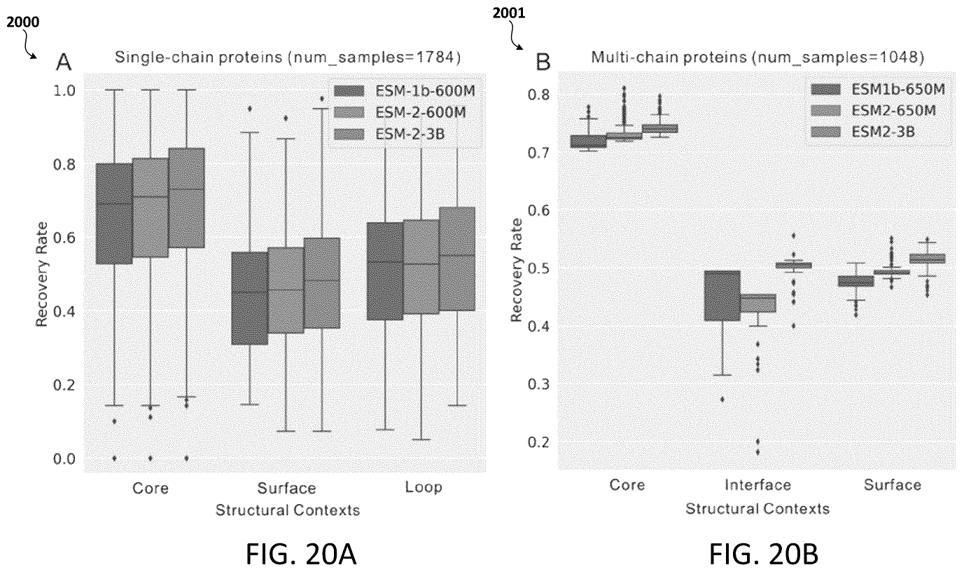

To study the impact of the model scale of the protein language model on single-chain and multi-chain protein design, their performance was evaluated in different structural contexts. As shown in the chart 2000 of FIG. 20A, the recovery rate of residues in the folding core increased from 65.2% (ESM-1b 650M) to 67.0% (ESM-2 650M), and finally to 69.3% using ESM-2 3B. For multi-chain proteins, ESM-2 3B also achieves the best recovery rate among different structure contexts (table 2001 of FIG. 20B). Therefore, the performance improvement can be found as a general trend for different structural contexts in sequence recovery when using a protein language model with a larger scale of parameters. This result suggests a larger protein language model benefit from the training on the larger-scale protein sequences.

Deep generative modeling typically formulates structure-based protein sequence design as a conditional sequence generation problem, wherein protein 3D structures can typically be represented as a k-NN graph. Several graph neural networks (GNNs) can be applied in this case to derive protein structural features. The protein graph establishes edge features between adjacent residues and encodes residue information as node features. The graph attention encoder and autoregressive decoder are used by GraphTrans for protein design. The novel geometric vector perceptrons which take into account both scalar and vector features, GVP improve further performance. Global graph attention for protein design is further introduced by GCA to capture long-range information. Recently, ProteinMPNN and PiFold introduce more complicated protein features and expressive GNNs and gain significant improvements. The machine learning model 101 is developed on top of the powerful structural capability of ProteinMPNN and PiFold. As such, the machine learning model 101 can further benefit from future progress in deep geometric learning for proteins.

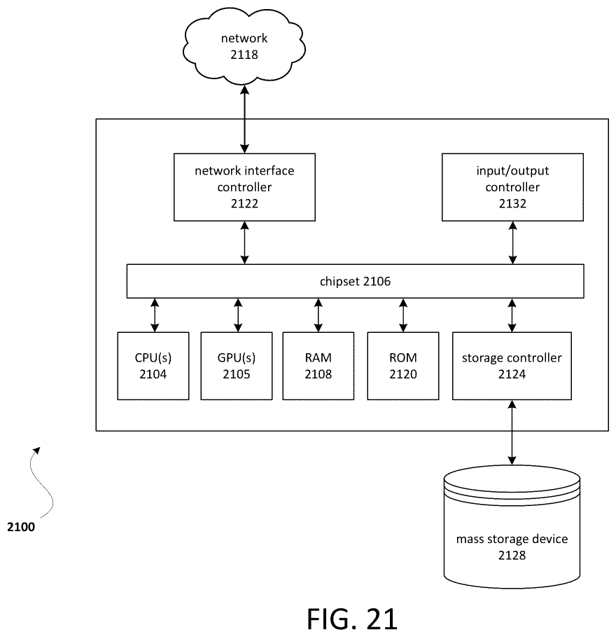

FIG. 21 illustrates a computing device that may be used in various aspects, such as the services, networks, modules, and/or devices depicted in any of FIGS. 1-2. With regard to FIGS. 1-2, any or all of the components may each be implemented by one or more instance of a computing device 2100 of FIG. 21. The computer architecture shown in FIG. 21 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 2100 may include a baseboard, or “motherboard,” which is a printed circuit board to which a multitude of components or devices may be connected by way of a system bus or other electrical communication paths. One or more central processing units (CPUs) 2104 may operate in conjunction with a chipset 2106. The CPU(s) 2104 may be standard programmable processors that perform arithmetic and logical operations necessary for the operation of the computing device 2100.

The CPU(s) 2104 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 2104 may be augmented with or replaced by other processing units, such as GPU(s) 2105. The GPU(s) 2105 may comprise processing units specialized for but not necessarily limited to highly parallel computations, such as graphics and other visualization-related processing.

A chipset 2106 may provide an interface between the CPU(s) 2104 and the remainder of the components and devices on the baseboard. The chipset 2106 may provide an interface to a random-access memory (RAM) 2108 used as the main memory in the computing device 2100. The chipset 2106 may further provide an interface to a computer-readable storage medium, such as a read-only memory (ROM) 2120 or non-volatile RAM (NVRAM) (not shown), for storing basic routines that may help to start up the computing device 2100 and to transfer information between the various components and devices. ROM 2120 or NVRAM may also store other software components necessary for the operation of the computing device 2100 in accordance with the aspects described herein.

The computing device 2100 may operate in a networked environment using logical connections to remote computing nodes and computer systems through local area network (LAN). The chipset 2106 may include functionality for providing network connectivity through a network interface controller (NIC) 2122, such as a gigabit Ethernet adapter. A NIC 2122 may be capable of connecting the computing device 2100 to other computing nodes over a network 2116. It should be appreciated that multiple NICs 2122 may be present in the computing device 2100, connecting the computing device to other types of networks and remote computer systems.

The computing device 2100 may be connected to a mass storage device 2128 that provides non-volatile storage for the computer. The mass storage device 2128 may store system programs, application programs, other program modules, and data, which have been described in greater detail herein. The mass storage device 2128 may be connected to the computing device 2100 through a storage controller 2124 connected to the chipset 2106. The mass storage device 2128 may consist of one or more physical storage units. The mass storage device 2128 may comprise a management component 2110. A storage controller 2124 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 2100 may store data on the mass storage device 2128 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 2128 is characterized as primary or secondary storage and the like.

For example, the computing device 2100 may store information to the mass storage device 2128 by issuing instructions through a storage controller 2124 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 2100 may further read information from the mass storage device 2128 by detecting the physical states or characteristics of one or more particular locations within the physical storage units.

In addition to the mass storage device 2128 described above, the computing device 2100 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 2100.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 2128 depicted in FIG. 21, may store an operating system utilized to control the operation of the computing device 2100. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 2128 may store other system or application programs and data utilized by the computing device 2100.

The mass storage device 2128 or other computer-readable storage media may also be encoded with computer-executable instructions, which, when loaded into the computing device 2100, transforms the computing device from a general-purpose computing system into a special-purpose computer capable of implementing the aspects described herein. These computer-executable instructions transform the computing device 2100 by specifying how the CPU(s) 2104 transition between states, as described above. The computing device 2100 may have access to computer-readable storage media storing computer-executable instructions, which, when executed by the computing device 2100, may perform the methods described herein.

A computing device, such as the computing device 2100 depicted in FIG. 21, may also include an input/output controller 2132 for receiving and processing input from a number of input devices, such as a keyboard, a mouse, a touchpad, a touch screen, an electronic stylus, or other type of input device. Similarly, an input/output controller 2132 may provide output to a display, such as a computer monitor, a flat-panel display, a digital projector, a printer, a plotter, or other type of output device. It will be appreciated that the computing device 2100 may not include all of the components shown in FIG. 21, may include other components that are not explicitly shown in FIG. 21, or may utilize an architecture completely different than that shown in FIG. 21.

As described herein, a computing device may be a physical computing device, such as the computing device 2100 of FIG. 21. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for generating protein sequences using machine learning models, comprising:
configuring a machine learning model by implanting a structural adapter into a sequence decoder, wherein the machine learning model is configured to generate a protein sequence from a specified structure, wherein the machine learning model is endowed with protein structural awareness by the structural adapter, wherein the machine learning model is equipped with protein sequential evolutionary knowledge by the sequence decoder, and wherein the machine learning model comprises the structural adapter, the sequence decoder, and a structure encoder;
generating an initial sequence based on the specified structure by the structure encoder; and
optimizing the protein sequence through an iterative process, wherein the iterative process comprises progressively refining the protein sequence by iterative decoding, and wherein the structural adapter non-linearly imposes representations of the specified structure on a sequence predicted in the iterative process.

2. The method of claim 1, further comprising:
generating a functionally valid sequence for structurally non-deterministic regions by the machine learning model.

3. The method of claim 2, wherein the machine learning model is enabled to handle the structurally non-deterministic regions based on the protein sequential evolutionary knowledge, and wherein the machine learning model is structurally sensitive to determine nuanced sequential specificity of protein groups with structural similarity.

4. The method of claim 1, further comprising:
synthesizing diverse and structurally valid sequences by the machine learning model.

5. The method of claim 1, further comprising:
generating antibody sequences or de novo protein sequences by the machine learning model.

6. The method of claim 1, wherein the machine learning model is modularizable, wherein the sequence decoder and the structure encoder have been pretrained, and wherein only the structural adapter is trained during a training process of the machine learning model.

7. The method of claim 1, wherein the structural adapter comprises a multi-head attention and a bottleneck feedforward network (FFN), and wherein the structural adapter is configured to acquire protein geometric information from the structure encoder.

8. The method of claim 1, wherein the iterative process further comprises:
sampling the predicted sequence via greedy deterministic decoding.

9. The method of claim 1, wherein the machine learning model is trained to reconstruct a protein native sequence from its corrupted version, which enables the machine learning model to iteratively refine the predicted sequence.

10. The method of claim 1, wherein the sequence decoder comprises a pretrained protein language model, and wherein the pretrained protein language model has learned the protein sequential evolutionary knowledge from protein sequence data.

11. The method of claim 1, wherein the structure encoder is pretrained, and wherein the pretrained structure encoder is kept frozen during a training process of the machine learning model.

12. A system for generating protein sequences using machine learning models, comprising:
at least one processor; and
at least one memory communicatively coupled to the at least one processor and comprising computer-readable instructions that upon execution by the at least one processor cause the at least one processor to perform operations comprising:
configuring a machine learning model by implanting a structural adapter into a sequence decoder, wherein the machine learning model is configured to generate a protein sequence from a specified structure, wherein the machine learning model is endowed with protein structural awareness by the structural adapter, wherein the machine learning model is equipped with protein sequential evolutionary knowledge by the sequence decoder, and wherein the machine learning model comprises the structural adapter, the sequence decoder, and a structure encoder;
generating an initial sequence based on the specified structure by the structure encoder; and
optimizing the protein sequence through an iterative process, wherein the iterative process comprises progressively refining the protein sequence by iterative decoding, and wherein the structural adapter non-linearly imposes representations of the specified structure on a sequence predicted in the iterative process.

13. The system of claim 12, the operations further comprising:
generating a functionally valid sequence for structurally non-deterministic regions by the machine learning model.

14. The system of claim 12, the operations further comprising:
synthesizing diverse and structurally valid sequences by the machine learning model.

15. The system of claim 12, the operations further comprising:
generating antibody sequences or de novo protein sequences by the machine learning model.

16. The system of claim 12, wherein the machine learning model is modularizable, wherein the sequence decoder and the structure encoder have been pretrained, and wherein only the structural adapter is trained during a training process of the machine learning model.

17. A non-transitory computer-readable storage medium, storing computer-readable instructions that upon execution by a processor cause the processor to implement operations comprising:
configuring a machine learning model by implanting a structural adapter into a sequence decoder, wherein the machine learning model is configured to generate a protein sequence from a specified structure, wherein the machine learning model is endowed with protein structural awareness by the structural adapter, wherein the machine learning model is equipped with protein sequential evolutionary knowledge by the sequence decoder, and wherein the machine learning model comprises the structural adapter, the sequence decoder, and a structure encoder;
generating an initial sequence based on the specified structure by the structure encoder; and
optimizing the protein sequence through an iterative process, wherein the iterative process comprises progressively refining the protein sequence by iterative decoding, and wherein the structural adapter non-linearly imposes representations of the specified structure on a sequence predicted in the iterative process.

18. The system of claim 12, the operations further comprising:
generating a functionally valid sequence for structurally non-deterministic regions by the machine learning model.

19. The system of claim 12, the operations further comprising:
synthesizing diverse and structurally valid sequences by the machine learning model.

20. The system of claim 12, the operations further comprising:
generating antibody sequences or de novo protein sequences by the machine learning model.
